(19) United States
(12) Patent Application Publication
(10) Pub. No.: US 2024/0159430 A1
(43) Pub. Date: May 16, 2024

(54) Apparatus for determining duration of hot water release from a boiler

(71) Applicant: Arnold Rubner, Jerusalem (IL)

(72) Inventor: Arnold Rubner, Jerusalem (IL)

(21) Appl. No.: 18/549,912

(22) PCT Filed: Apr. 3, 2022
(86) PCT No.: PCT/IB2022/053091

§ 371 Date: Sep. 10, 2023

Related U.S. Application Data
(60) Provisional application No. 63/170,587, filed on Apr. 5, 2021.

(51) Int. Cl. F24H 15/174; F24D 17/00; F24H 15/225; F24H 15/238

(52) U.S. Cl. CPC F24H 15/174; F24D 17/00; F24H 15/225; F24H 15/238

(57) ABSTRACT

An apparatus which reads, measures, or otherwise monitors the temperature of a boiler (102, 202) at two points on the boiler, determines the amount of hot water currently available for a usage, such as a hot shower, at approximately 37° C. to 40° C., expressed in terms of time, and displays the time on a display (222) of the device.

### CROSS-REFERENCES TO RELATED APPLICATIONS

This application is related to and claims priority from commonly owned U.S. Provisional Patent Application Ser. No. 63/170,587, entitled: Apparatus For Determining Duration Of Hot Water Release From A Boiler, filed on Apr. 5, 2021, the disclosure of which is incorporated by reference in its entirety herein.

### TECHNICAL FIELD

The present disclosure is directed to apparatus for determining amounts of hot water in boilers, for distribution.

### BACKGROUND

In many areas of the world, domestic hot water supplies are in the form of tanked hot water, stored in and distributed from heated tanks, also known as boilers. The boilers are largely heated by solar energy but can be heated by electric power. Most non-tanked instant hot water systems are also set up in conjunction with a tanked system, which uses the “instant hot” as backup. Common domestic tank sizes range from 30-200 liters capacity. Calculating suitable sizing of a hot water tank for consumer requirements is usually based on the number of persons in the household together with house size, and generally ensures that a sufficient amount of hot water is available.

Although tanked hot water systems are more energy efficient, heating the water takes time and can often be a problem when the regular hot water requirement changes with behavioral changes of the household members, or when the amount of people in the household increases, as more hot water is needed. This can lead to the unpleasant situation of having the water turn cold while showering.

### SUMMARY

Embodiments of the disclosed subject matter provide methods and systems for determining amounts and capacities of hot water, for example, at approximately 37° C. to approximately 40° C., available for use at a given time. The uses include, for example, showers, baths, sinks, laundry washers, dish washers, and the like.

Embodiments of the disclosed subject matter provide an apparatus or device, which reads, measures, or otherwise monitors the temperature of a boiler at two points on the boiler. Based on temperature readings at these two points, and one or more parameters, such as the volume of the boiler tank, shower flow rate, the type of boiler-horizontally or vertically oriented, and, the processor determines the amount of hot water available to a user, for example, for a hot (approximately 37 Celsius (C or ° C.) to 40 C) shower, in terms of time, for example, minutes and seconds. The device is such that at any given time, the amount of hot water currently available for a hot shower, at approximately 37° C. to 40° C. is displayed in terms of time, by a display of the device.

The device can be installed on any type of tanked boiler, without any special or customized hardware, software or the like. While a shower is described, the device is also suitable to provide available time lengths for baths, sinks, laundry, dishes, and the like.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF FIGURES

Non-limiting examples of embodiments are described below with reference to figures attached hereto that are listed following this paragraph. Identical structures, elements or parts that appear in more than one figure are generally labeled with a same numeral in all the figures in which they appear, and a numeral labeling an icon representing a given feature in a figure may be used to reference the given feature. Dimensions of components and features shown in the figures are chosen for convenience and clarity of presentation and are not necessarily shown to scale.

FIG. 1 is a diagram of a boiler suitable for use with the disclosed subject matter;

FIG. 2 is a block diagram of a system employed with a boiler in accordance with the disclosed subject matter;

FIG. 3A and FIG. 3B are illustrations of a display of the apparatus of the disclosed subject matter;

FIG. 4A-1, FIG. 4A-2, and FIG. 4B, are diagrams of boilers in accordance with the disclosed subject matter;

FIG. 5 is a chart of temperature versus hot water availability time for a shower at approximately 37° C.;

FIG. 6A and FIG. 6B are a flow diagram detailing an example operation of the system of the disclosed subject matter;

FIG. 7 is another chart of temperature versus hot water availability time when cold water temperature of mains water is part of the calculation for available shower time;

FIG. 8A is a block diagram of another apparatus employed with a boiler for receiving cold water temperatures via a communication link, in accordance with the disclosed subject matter; and

FIG. 8B is an example display for the apparatus of FIG. 8A.

### DETAILED DESCRIPTION

Throughout this document, references to directions, such as upward, downward, upper, lower, up, down, top, bottom, and the like, are made. These directional references are to typical orientations for the structures, such as boilers, also known as boiler tanks or tanks, these terms used interchangeably herein. They are exemplary only, and not limiting in any way, as they are for description and explanation purposes.

The disclosed subject matter provides methods, systems and software products and which read, measure, or otherwise monitor the temperature of a boiler at two points on a boiler, to determine the amount of hot water currently available at a given time for a usage, such as a hot shower, at approximately 37° C. to 40° C., expressed in terms of time, and displays the time on a display of the device.

### System Overview

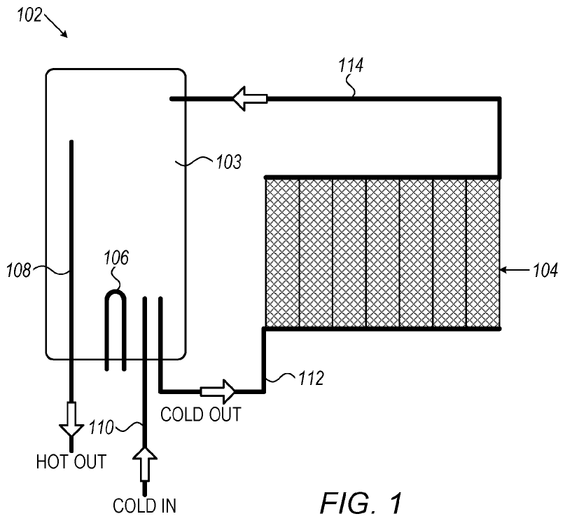

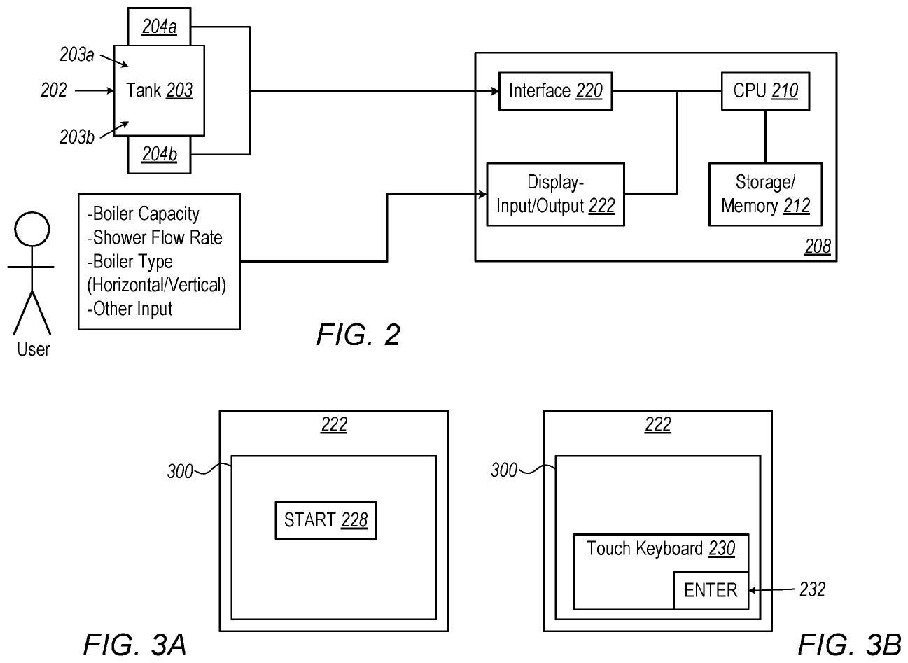

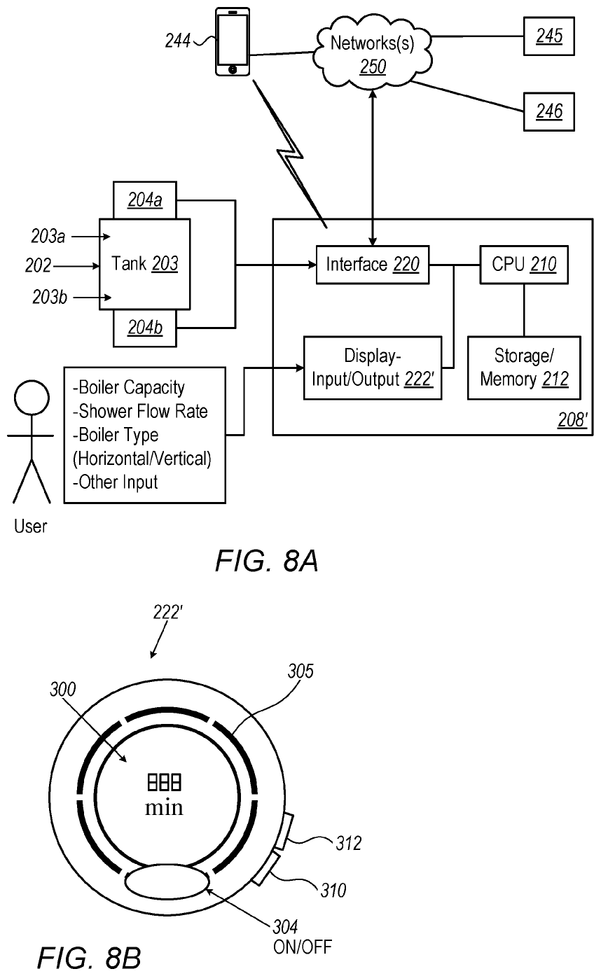

FIG. 1 shows a boiler 102 which is suitable for use with the disclosed apparatus 208 (FIG. 2) 208′ (FIG. 8A). The boiler 102 heats water and holds the hot water, for example, for distribution through a plumbing system, it for domestic use, such as showers, baths, sinks, laundry, dishes, and the like. The boiler 102, includes a tank 1023, and is, for example purposes, in a stratified state, as heated water, heated by either a solar panel 104 or heating element 106 (heater) moves upward, to the top of the tank 103, so as to reside in the upper portion of the tank 103. When use is desired, the heated water is drawn from a tube 108, which extends upward, into the upper portion of the tank 103. Cold water, such as tap water or source water enters the tank 103 through an inlet tube 110, which extends into the lower portion of the tank 103. A feed tube or line 112 extends from the lower portion of the tank 103 into the solar panel 104, to provide water to the solar panel 104, which heats the water. The hot water is released from the solar panel 104 to an outlet tube 114, which releases the heated (hot) water, into the tank 103 at the upper portion. In this boiler 102, the solar panel 104 and its feed 112 and outlet 114 tubes are optional.

### System Description

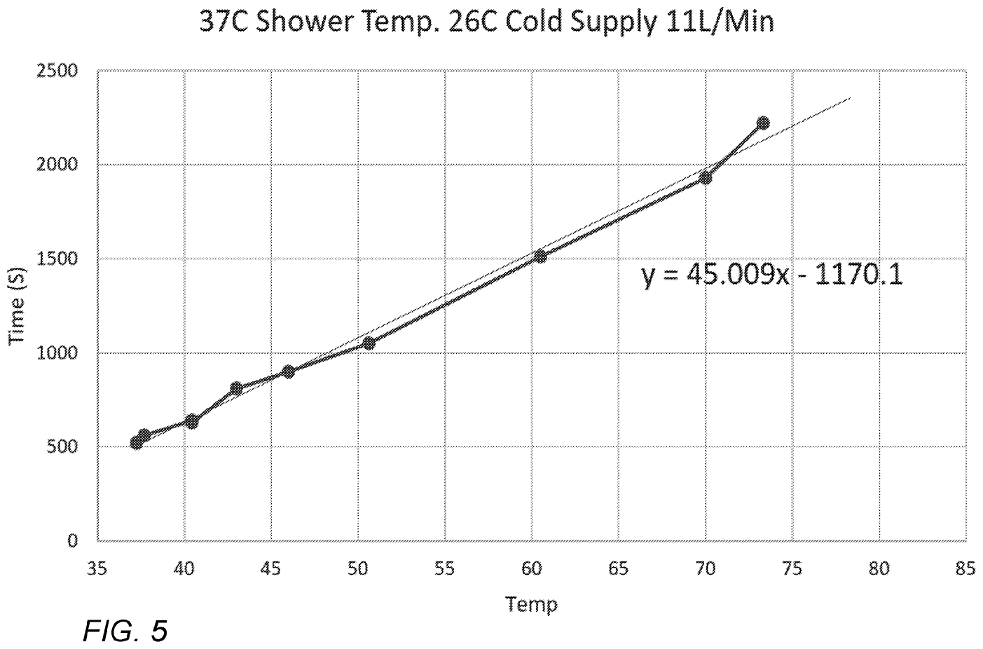

Reference is now made to FIG. 2, is a block diagram of an apparatus 208 for use with a boiler 202, for example, similar to the boiler 102 of FIG. 1. The apparatus 208 applies temperature readings from sensors 204a (top or upper), 204b (bottom or lower), coupled with boiler 202 tank 203 volume, outflow rate, and boiler type, vertical 202v, 200v′, as shown in FIG. 4A-1 and FIG. 4A-2, respectively, or horizontal 202h, as shown in FIG. 4B, to determine the amount of time, the user will have hot water, at approximately 37° C. to 40° C., for a domestic use, such as a shower.

A first or top sensor 204a is, for example, positioned at or proximate to the top of the boiler 202 (for example, in a thermowell 416a (FIG. 4A-1)), at the upper portion of the boiler 202, to sense, read, or otherwise measure the water temperature inside the tank 203 of the boiler 202. The boiler 202 is, for example, in a stratified state, as the boiler 202 is associated with a solar panel, for example, as shown in FIG. 4A-1. The hottest water is, for example, at the top of the tank 203, or upper portion 203a of the tank 203, while the coldest water is, for example, at the bottom or lowermost portion 203b of the tank 203, of the boiler 202. Accordingly, a second or bottom sensor 204b is positioned at or proximate to the bottom of the boiler 202 (for example, in a thermowell 416b (FIG. 4A-1)), at the lower or bottom portion of the boiler 202, to sense, read, or otherwise measure, the water temperature inside the tank 203 of the boiler 202. The top sensor 204a and bottom sensor 204b communicate with the apparatus 208 by wired connections, wirelessly, or by combinations thereof.

The apparatus 208 includes a processor 210 linked to storage/memory 212, an interface 220 and a display 222. These components 210, 212, 220, 222, are in communication, either directly or indirectly, with each other, and while one arrangement of these components is shown, this is exemplary only, as numerous arrangements of these components are permissible.

The processor 210, for example, receives signals and/or data from the sensors 204a, 204b either directly or through the interface 220. Also, through the interface 220, either via the display 222, or through networks, such as the Internet, as the interface 220 communicates with the Internet and other networks via WiFi®, other wireless signals, and the like. The interface 220, for example, may be a transceiver, functioning as a receiver to receive boiler 202v, 202v′, 202h, temperatures from each of the sensors 204a, 204b, and user inputs, for example, of boiler 202 capacity (tank 203 volume), water (e.g., shower) flow rate, for example, between 5 to 25 liters per minute, boiler type, e.g., horizontal or vertical, and optionally, shower water temperature, for example, from approximately 37° C. to approximately 40° C., with divisions including 37° C. for warm, 38° C. for very warm, 39° C. for hot, and, 40° C. for very hot. In the case where values are not received via the interface 220, after prompting of the user, and/or a predetermined amount of time, default values, for example, of 120 liters for boiler capacity, 11 liters/minute for flow rate, vertical orientation for the boiler, and showering temperature of 37° C. are used by the memory (of the storage/memory 212), and the processor 210. The interface 220, for example, may also function as a transmitter, to transmit the available shower time to the display 222. The interface 220, for example, may also be connected to the wiring of the heating element for the boiler 202v, 202v′, 202h to control the heating of the boiler according to the shower time requested by a user.

The processor 210 may, for example, be a Central Processing Unit (CPU), formed of one or more processors, including microprocessors, for performing the functions and operations detailed herein, including controlling the components 220, 222, and executing the instructions provided and/or obtained therefrom, including those from the storage/memory 212. The Central Processing Unit (CPU) 210 processors are, for example, conventional processors, such as those used in servers, computers, and other computerized devices, including data processors and hardware processors, such as x86 Processors from Advanced Microdevices (AMD) and Intel, Xenon® and Pentium® processors from Intel, as well as any combinations thereof.

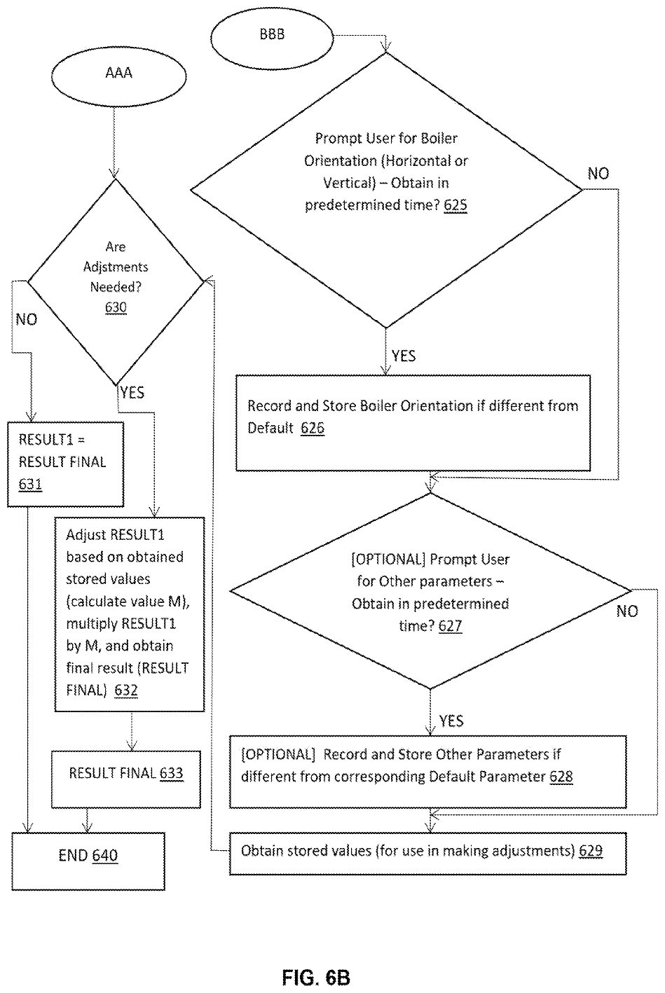

The storage/memory 212 is associated with the CPU 210, and is any conventional storage media. The storage/memory 212 also includes machine executable instructions associated with the operation of the CPU 210 and the components 220, 222, and along with the processes and subprocesses shown in FIG. 6A and FIG. 6B, detailed herein. The storage/memory 212 also, for example, stores rules and policies for the apparatus 208.

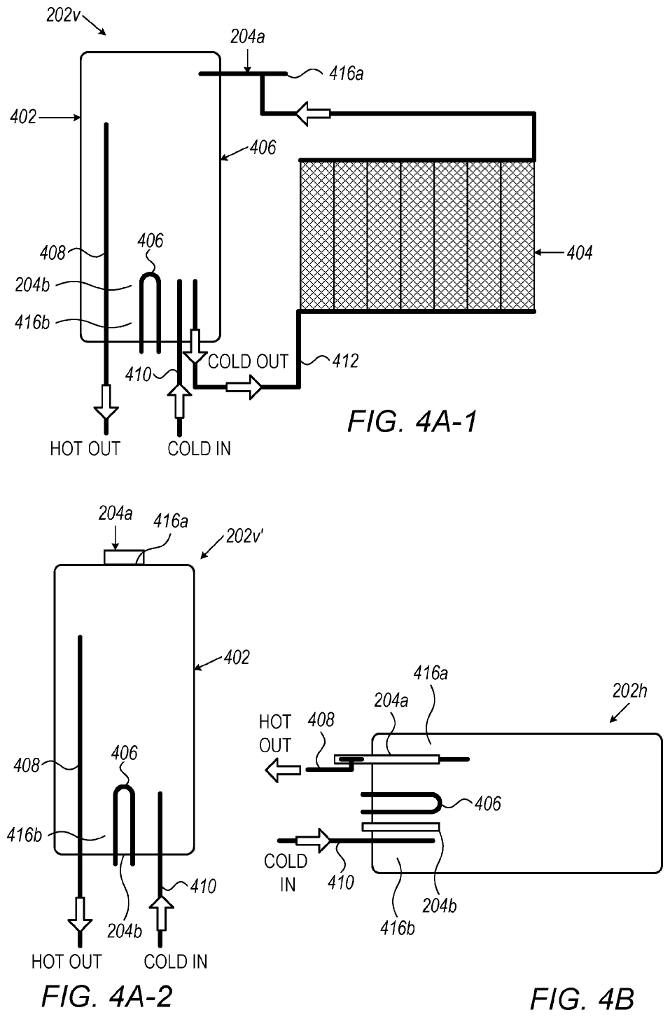

FIG. 3A and FIG. 3B show the display 222, which, for example, is a touch screen, liquid crystal (LCD) display, or other display. The display 222, for example, includes a touch screen 300, and supports various buttons, such as START 228 (FIG. 3A) and END buttons, and a keypad 230 (e.g., a QWERTY keyboard with numerals and an ENTER button 232) through which user selections and actions are input, and output is displayed. The default display 222 (display screen), shown in FIG. 3A displays a START button 228, that one contacted activates the processor 210 to calculate the time for a hot shower, for, example, in real time. The display 222, for example, may also include push buttons and switches, to turn the apparatus 208 on and off, to obtain an available time length for a hot shower.

Alternately, the display 222 may be a liquid crystal (LED) display. For example, this LED display may accept limited input from the user, such as shower flow rate, and outputs, for display, the available time for a shower. It may also include push buttons and switches, to turn the apparatus 200 ON and OFF, to obtain an available time length for a hot shower.

FIG. 4A-1 shows a vertical boiler 202v with a solar panel or solar panel heater in accordance with an embodiment of the disclosed subject matter. The boiler 202v, includes a tank 402, and receives heated water, heated by either a solar panel 404 or a heating element 406 (heater). When the solar panel 404 heats the water, the boiler 202v is, for example, in a thermally stratified state, and is considered to be a stratified boiler. The heated water moves upward in the tank 402, to the top of the tank 402, so as to reside in the upper portion of the tank 402.

When use is desired, the heated water is drawn from a draw tube 408, which extends upward, into the upper portion of the tank 402. Cold water, such as tap water or source water enters the tank 402 through an inlet tube 410, which extends into the lower portion of the tank 402. A feed tube or line 412 extends from the lower portion of the tank 402 into the solar panel 404, to provide water to the solar panel 404, which heats the water. The hot water is released from the solar panel 404 to an outlet tube 414, which releases the heated (hot) water, into the tank 402 at the upper portion. Sensors, top 204a, and bottom 204b, are located in thermowells, upper 416a, and lower 416b. The upper thermowell 416a, is for example, connected or proximate to the outlet tube 414, while the lower thermowell 416 is, for example, at the base of the tank 402, for example, together with the thermostat (not shown) for the boiler 202v. The sensors 204a, 204b communicate by wired and/or wireless links to the apparatus 200 (FIG. 2). In this boiler 202v, the solar panel 404 and its feed 412 and outlet 414 tubes are optional, as the heating element 406 may provide the necessary heat to render the water in the tank 402 to heated state (e.g. up to 70° C.)

FIG. 4A-2 shows a vertical boiler 202v′, such as that shown in FIG. 4A-1, without the solar panel heater 404, with identical or similar components taking the element numbers, and functions as described above for the vertical boiler 202v of FIG. 4A-1. The water is heated by the heating element (heater) 406. Depending on the temperature difference between the top 204a and bottom 204b temperature sensors, the boiler 202v′ operates in a non-stratified state, when the temperature difference is, for example, less than a predetermined temperature (threshold temperature) (for example, as programmed into the CPU 210), for example, less 2° C., and, operates in a stratified state, when the temperature difference is for example, greater than a predetermined temperature (threshold temperature), for example, greater than 2° C.

FIG. 4B shows a horizontal boiler 202h in accordance with an embodiment of the disclosed subject matter. Identical or similar components for the boiler 202h are provided with identical numbering and are in accordance with that described for the vertical boilers 202v, 202v′ detailed above, and shown in FIG. 4A-1 and FIG. 4A-2. The boiler 202h includes a tank 402, and receives heated water, heated by a heating element 406 (heater). The centrally elevated position of the heating element 406 is such that the heated water, for example, moves upward, to the top of the tank 402, so as to reside in the upper portion of the tank 402. When use is desired, the heated water is drawn from a draw tube 408, which extends into the upper portion of the tank 402. Cold water, such as tap water or source water enters the tank 402 through an inlet tube 410, which extends into the lower portion of the tank 402. Sensors, top 204a, and bottom 204b, are located in thermowells, upper 416a, and lower 416b. The upper thermowell 416a, is for example, connected or proximate to the draw tube 414, while the lower thermowell 216 is, for example, at the base of the tank 402, for example, together with the thermostat (not shown) for the boiler 202h. The sensors 204a, 204b communicate by wired and/or wireless links to the apparatus 200.

With the heating element 406 at an approximately central elevation, this boiler 202h may operate in both stratified and non-stratified states, depending on a predetermined or threshold temperature difference (for example, as programmed into the CPU 210) between the top 204a and bottom 204b temperature sensors. For example, the boiler 202h operates in a non-stratified state, when the temperature difference is, for example, less than the predetermined or threshold temperature, e.g., 2° C., and, operates in a stratified state, when the temperature difference is, for example, greater than the predetermined or threshold temperature.

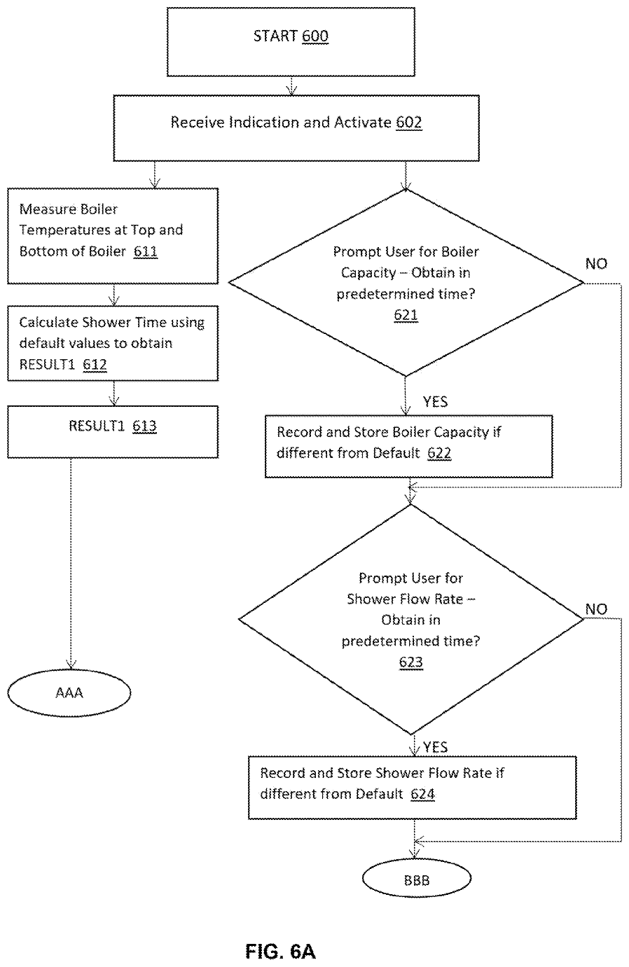

FIG. 5 is a diagram of an example of a default shower time (in seconds-y axis) versus temperature (in Celsius-x axis), at a flow rate of approximately 11 liters/minute for a shower of temperature of approximately 37° C. for an approximately 120 liter boiler (boiler tank), these are the calibration and/or default parameters, with intake cold water of approximately 26° C.

### Example 1

These parameters, constants and equation of FIG. 5 is used in the following example. Additionally, in the following example, the intake cold water temperature is not taken into account when determining the available shower time, as the default equation, from FIG. 5 is being used. This default equation of FIG. 5 includes an Equation, shown below as Equation 1, for available shower time (T_{AV}), expressed as “y”, with constants of 45.009 as K₁, and 1170.1 as K₂, and “x”, where “x” is a virtual bottom temperature (T_{VB}), all of these values applied in Equations 1-3 below. Based on this diagram, for a boiler in a stratified state, with a top temperature (T_{TOP}) of 60° C., and a bottom temperature (T_{BOT}) of 40° C., and intake cold water (into shower mixer from mains water supply) of approximately 26° C., the available shower time (T_{AV}) in seconds, is calculated in accordance with the formula:

T_{AV}=(T_{VB}·K₁)−K₂ (Equation 1)

where, K₁ is a constant of 45.009, K2 is a constant of 1170.1, and T_{VB} is a virtual bottom temperature, expressed by the equation:

T_{VB}=(ΔT·K_{BV})+T_{BOT} (Equation 2)

where, ΔT is the temperature difference in the boiler between the temperature measured by the top sensor (204a) T_{TOP} and the temperature measured by the bottom sensor (204b) T_{BOT}, in accordance with the equation:

ΔT=T_{TOP}−T_{BOT} (Equation 3)

and K_{BV} is a constant based on the volume of the boiler (boiler tank), which for a 120 liter boiler tank is 0.3.

For example, for the 120 liter boiler tank, with the top measured temperature T_{TOP} of 60° C. and the bottom measured temperature T_{BOT} of 40° C.:

T_{VB}=((60C−40C)*0.3)+40C=6C+40C=46C, whereby the available shower time (T_{AV}) is:

T_{AV}=(46·45)−1170=2070−1170=900 seconds, or 15 minutes (900 sec/60 sec/min).

Should there be any adjustments due to parameter differences from the calibration or default parameters, the available shower time (T_{AV}) is adjusted proportionally by any modifications (M), to yield an augmented or modified result (T_{AV}), which is expressed as:

T_{AV}=T_{AV}·M (Equation 4)

The modifications are, for example, proportional adjustments based on proportional differences between 120 liters for boiler capacity, 11 liters/minute for water flow rate, and for a horizontal boiler rather than a vertical boiler.

For example, if the boiler volume is 150 liters, or 1.25 times greater than the calibration volume of 120 liters, and the flow rate is 15 liters/minute, or 1.36 times faster than the calibration of 11 liters/minute T_{AV} is multiplied by 1.25/1.36 or M, which is 0.91, such that the available time for a shower (T_{AV}) is expressed as:

T_{AV}=900 seconds·0.91=819 seconds or 13.65 minutes (819 sec/60 sec/min).

Other modifications, for example, include applying a parameter difference of showering temperature, for example, based on Table 1, where the showering temperature selected by the user, will modify the available shower time (T_{AV}) by a multiplier in accordance with TABLE 1.

TABLE 1

Temperature (° C.)

| | 37 | 38 | 39 | 40 |
|---|---|---|---|---|
| K_{TEMP} | 1 | 0.93 | 0.86 | 0.80 |

Using TABLE 1, for example, an available shower time (T_{AV}) of 900 seconds at 37° C., was established using Equations 1-3. Now, the user wants to shower at 39° C. Equation 5 is used to determine this new available time (T_{AV-NEW}) as follows:

T_{AV-NEW}=T_{AV}·K_{TEMP} (Equation 5),

which results in T_{AV-NEW}=900 sec·0.86 (from TABLE 1)=774 seconds, the 774 seconds or 12.9 minutes (774 sec/60 sec/min), being the length of time for a shower at 39° C.

FIG. 6A and FIG. 6B are a flow diagram showing an example process, in accordance with an embodiment of the disclosed subject matter. The process is, for example, performed automatically, and references the apparatus and charts detailed in FIG. 2 to FIG. 5. The process is, for example, performed automatically and in real time.

The process begins at a START block 600. At this block 600, default values are set, for example, for boiler capacity, e.g., at 120 liters, water flow rate, e.g., at 11 liters/minute, boiler type, e.g., vertical, as shown by the boilers 202v (FIG. 4A-1), 202v′ (FIG. 4A-2), and optionally, other parameters. The formula for determining the shower time length is programmed into the processor 210, and is, for example, in accordance with Equations 1-4, as detailed above. The constants, K1, K2 and KVB, may, for example, be taken From FIG. 5 and EXAMPLE 1 above.

At block 602, an indication is received, resulting from user input into the display 222 (or the user turning the apparatus ON, by push button switch, or the like on the display 222), to determine the available time for a “hot” shower (or alternately, bath, sink, laundry dishes, or the like). The process moves to the blocks of the 610 series (blocks 611, 612, 613) and 620 series (blocks 621, 622, 623, 624, 625, 626, 627, 628, 629), for example, contemporaneously, and this may be simultaneously, or one series 610, 620 after the other.

In the blocks of the 610 series, with the indication received at block 602, the process moves to block 611, where top and bottom boiler 202v temperatures are measured. With the temperatures now measured, the process moves to block 612, where the temperatures are input into the processor 210, which runs the calculations of Equations 1-3, with the temperatures and the default values, preset and/or pre-programed into the processor 210, and calculates the available shower time as RESULT1. With the calculations complete, a result, e.g., a length for a shower time, indicated as RESULT1 is indicated, at block 613. From block 613, the process moves to block 630.

Returning to block 602, the process moves to the 620 series and block 621. At block 621, the user is prompted to enter the boiler capacity, within a predetermined time. Should the boiler capacity be entered, which is different from the default boiler capacity, the different value is recorded and stored in the memory 212, at block 622, and the process moves to block 623. Returning to block 621, if an entry is not received from the user in the predetermined time period, the process moves to block 623.

At block 623, the user is prompted to enter the water flow rate for the boiler, within a predetermined time. Should the boiler flow rate be entered, which is different from the default boiler flow rate, the different value is recorded and stored in the memory 212, at block 624, and the process moves to block 625. Returning to block 623, if an entry is not received from the user in the predetermined time period, the process moves to block 625.

At block 625, the user is prompted to enter the orientation, e.g., horizontal or vertical, for the boiler, within a predetermined time. Should the boiler orientation be horizontal, which is different from the default boiler vertical orientation, this different orientation is recorded and stored in the memory 210, at block 626, and the process moves to block 627. Returning to block 625, if an entry is not received from the user in the predetermined time period, the process optionally moves to block 627.

At optional block 627, with represents the entry of other parameters (blocks 627 and 628 may repeat for each other parameter) the user is prompted to enter the parameter, within a predetermined time. Should the parameter be different from the corresponding default parameter, this parameter is recorded and stored in the memory 210, at optional block 628, and the process moves to block 629.

As blocks 627 and 628 are optional, should there not be any other parameters, blocks 627 and 628 are not relevant, and the process moves from block 625 or 626, to block 629.

At block 629, the stored values, which are different from the default values are obtained, as these values will be used when making adjustments to the available shower time (RESULT1 of block 631). The process moves to block 630.

At block 630, it is determined whether there are any adjustments to be made to the length of available shower time. If no, as no values were obtained at block 622, 624, 626, and optionally 628, the process moves to block 631, where the time length, e.g., RESULT1 remains the same as the Final Result (RESULT FINAL), and the process moves to block 640, where it ends.

If there are adjustments to be made, based on receiving values different from the default values at block 629, the process moves to block 632, where an adjustment value M is calculated. Also at block 632, the initial result, e.g., RESULT1, is adjusted by the modifier M, in accordance with Equation 4 and/or Equation 5. This modified or augmented result RESULT FINAL is now the final result, at block 633.

From block 633, the process moves to block 640, where it ends. The process may be repeated for as long as desired, each time a user inputs a request, which is an indicator to the system to calculate the available time for a hot shower.

Alternately, at a minimum, one temperature, for example, the bottom temperature (T_{BOT}) of the boiler, need only be read. In this case, Equations 1-4 are applied, as discussed above, such that the available shower time (T_{AV}), is calculated where Equation 2 above becomes T_{VB}=T_{BOT}, as ΔT, from Equation 3, would be “0” by default.

In other alternates, for example, an LCD display, as discussed above, may be such that the only parameter entered (input) by the user, would be the shower flow rate, as one boiler may serve more than one shower (or another bath, sink laundry washer, dish washer, or the like). The available shower time would be calculated with all default values, of Equations 1-3 above, adjusted in accordance with Equation 4 and/or Equation 5, should the shower flow rate be different than the default shower flow rate.

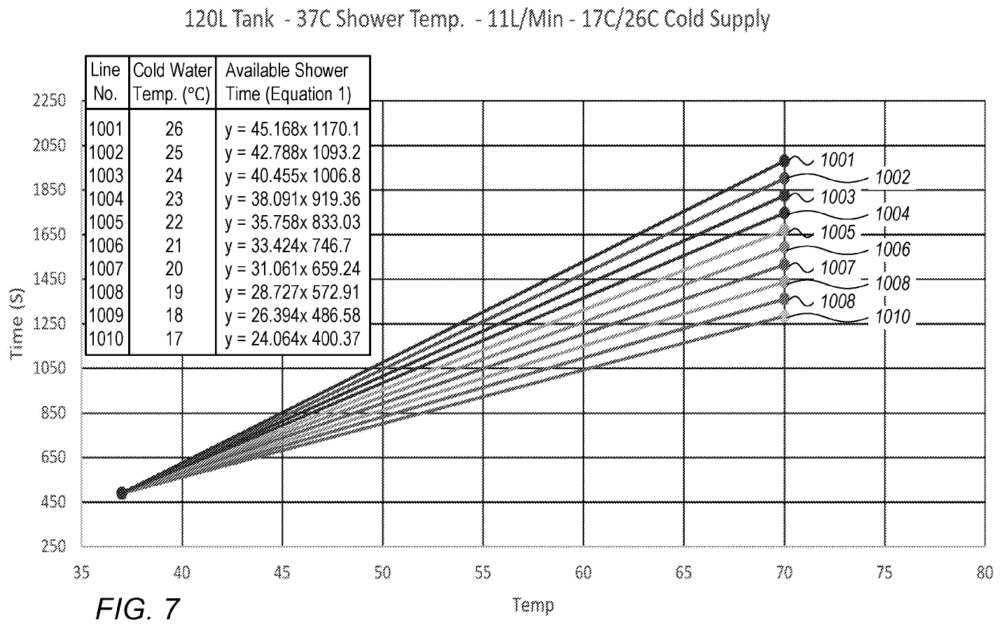

FIG. 7 is a diagram of an example of shower times (in seconds-y axis) versus temperature (in Celsius-x axis), at a flow rate of approximately 11 liters/minute for a shower of temperature of approximately 37° C. for an approximately 120 liter boiler (boiler tank), these are the calibration and/or default parameters, with intake cold water of approximately 26° C. or less (e.g., from approximately 17° C.-26° C.). FIG. 7 includes Equations, which are used as Equation 1, for available shower time (T_{AV}), expressed as “y”, with variable constants K₁, K₂, based on the various temperatures of the inlet or mains cold water, represented by the lines 1001 to 1010 in FIG. 7 and the corresponding legend in the upper left corner of the figure, and where “x” is a virtual bottom temperature (T_{VB}), such that all of these values are applied in Equations 1-3 below.

### Example 2

An example based on FIG. 7 and Equations 1-3 above, is for a boiler (e.g., a vertical boiler 202v, 202v′) in a stratified state, with a 120 liter tank, a flow rate of 11 liters/minute, a shower temperature of 37°, a top temperature (T_{TOP}) of 50° C., and a bottom temperature (T_{BOT}) of 35° C., and intake cold water (into the shower mixer from mains water supply) at 18° C. (line 1009 in FIG. 7), the available shower time (T_{AV}) in seconds, is calculated in accordance with the formula:

y=26.394x−486.58, which when used as Equation 1, where the constant K₁ is 26.394 (from FIG. 7 at line 1009), the constant K2 is 486.58 (from FIG. 7 at line 1009), and the constant K_{BV} is 0.3 (from EXAMPLE 1) is as follows:

T_{AV}=(K₁·T_{VB})−K2=(26.394·T_{VB})−486.58 (Equation 1)

Now, T_{VB}=(ΔT·K_{BV})+T_{BOT} (Equation 2)

where, ΔT is the temperature difference in the boiler between the temperature measured by the top sensor (204a) T_{TOP} and the temperature measured by the bottom sensor (204b) T_{BOT}, in accordance with the equation:

ΔT=T_{TOP}−T_{BOT}=50C−35C=15C (Equation 3)

and K_{BV} is a constant based on the volume of the boiler (boiler tank), which for a 120 liter boiler tank is 0.3.

Now, using Equation 2, T_{VB}=((50 C−35 C)·0.3)+35 C=4.5 C+35 C=39.5 C, whereby the available shower time (T_{A}V) from Equation 1 is:

T_{AV}=(26.394·39.5)−486.58=555.98 seconds, and,

T_{AV}=555.98/60=9.26 minutes of shower time.

FIG. 8A shows an apparatus 200′ similar to the apparatus 200 of FIG. 2, with similar elements represented by similar element numbers and taking the descriptions provided above. The apparatus 200′ is such that the interface 220 serves as a network interface (similar to that described for the interface 220 above) and a device interface. For example, a device 244, such as a smartphone, communicates with the network interface 220 via network(s) 250, such as communications networks, such as one or more of the Internet, cellular networks, other wide area networks (WAN), or the like, as well as directly with the network interface 220, by communications such as Bluetooth®. For example, a computer 245, or other server 246, also communicates with the interface 220 over the network 250. Via the aforementioned communications and the device 244 and computers 245, 246, a cold water temperature, such as that of mains water, for example, based on the day, month season, or the like, may be provided to (e.g., electronically and/or automatically and, for example, in real time), and obtained by the CPU 210 in calculating Equations 1-5 as well as Equations 6 and 7, detailed below. The cold water temperatures, e.g., for the mains water, may also be preprogrammed into the CPU 210.

FIG. 8B shows a display unit (or display) 222′, similar to the display unit (or display) 222 of FIGS. 3A and 3B. The display unit 222′ includes a display screen 300, an ON/OFF button 304, light (LED) bars 305, a menu button 310, which when depressed, brings up various control menus for the boiler, and a select button 312, from which menu options are selected, when the button 312 is depressed.

The light bars 305, five in total, are such that each lit bar 305 represents 20% of the boiler tank capacity being heated. When all five bars are lit, the boiler will provide maximum time of hot water for showering, based on boiler volume. Additionally, one or more of the bars 305 may flash to indicate a boiler tank temperature (e.g., a top temperature) of at least 85° C. (an unsafe temperature for boiler operation). When the user sees the flashing of the bars 305, this is an indication for the user to turn OFF the boiler, typically, immediately and organize inspection of a potentially faulty thermostat.

An additional equation set is provided to determine the percentage of boiler tank hot water capacity suitable for showering at a given time. The equations are as follows:

Initially, maximum shower time (TIME_{MAX}) is calculated by:

TIME_{MAX}=(70·K)−K₂ (Equation 6)

where 70 is 70° C., the maximum boiler temperature set on the boiler thermostat, K₁ and K₂ are the constants used for Equations 1-3 of EXAMPLE 1 above (and in certain cases, such as mains water (cold water) temperature being applied, K₁ and K₂ are taken from one of lines 1001 to 1010 of FIG. 7), for a 120 liter capacity boiler tank;

Capacity (CP) is expressed as:

CP=T_{AV}/TIME_{MAX} (Equation 7).

Embodiments of the disclosed subject matter are directed to a method for determining a time length for water usage at a predetermined temperature. The method comprises: measuring at least one temperature of a boiler tank; and, based on the at least the measured temperature, a volume of the boiler, and, a flow rate of liquid from the boiler tank, determining a length of time available for water usage at the predetermined temperature.

Optionally, the method is such that the predetermined temperature is between approximately 370 to approximately 40°.

Optionally, the method is such that the measuring the at least one temperature includes measuring the at least one temperature (T_{BOT}), either at, or proximate to, a bottom of the boiler tank.

Optionally, the method is such that the measuring the at least one temperature incudes measuring a second temperature (T_{TOP}), either at or proximate to a top of the boiler tank.

Optionally, the method is such that the measuring the bottom of the boiler tank and the top of the boiler tank are at oppositely disposed vertically oriented ends of the boiler tank.

Optionally, the method is such that the boiler tank includes a non-stratified boiler tank.

Optionally, the method is such that the boiler tank includes a stratified boiler tank.

Optionally, the method is such that the water usage includes a shower.

Optionally, the method is such that the determining a length of time available for water usage at the predetermined temperature (T_{AV}) is determined by the equation:

T_{AV}=(T_{VB}·K₁)−K₂,

where, K₁ is a constant of 45.009, K2 is a constant of 1170.1, and T_{VB} is a virtual bottom temperature, expressed by the equation:

T_{VB}=(ΔT·K_{BV})+T_{BOT},

where, ΔT is a temperature difference determined in accordance with the equation:

ΔT=T_{TOP}−T_{BOT},

where, T_{TOP} is the measured temperature from either at or proximate to a top of the boiler tank, and T_{BOT} is the measured temperature from either at or proximate to the bottom of the boiler tank, and K_{BV} is a constant based on the volume of the boiler (boiler tank) of 0.3.

Embodiments of the disclosed subject matter are directed to an apparatus for determining a time length for water usage at a predetermined temperature. The apparatus comprises: a receiver for receiving at least one temperature from a sensor in communication with a boiler tank; a non-transitory storage medium for storing computer components; and, a computerized processor in communication with the receiver and the non-transitory storage medium, the processor programmed to: determine a length of time available for water usage at the predetermined temperature, based on the at least the received at least one temperature, a volume of the boiler, and, a flow rate of liquid from the boiler tank.

Optionally, the apparatus is such that the at least one temperature includes two temperatures, each temperature received from at least one sensor, each at last one sensor in communication with the boiler tank, one at least one sensor in communication at or proximate to a bottom of the boiler tank, and, one at least one sensor in communication at or proximate to a top of the boiler tank.

Optionally, the apparatus is such that it additionally comprises: a first sensor comprising the at least one sensor in communication at or proximate to a bottom of the boiler tank, and, a second sensor comprising the at least one sensor in communication at or proximate to a top of the boiler tank.

Optionally, the apparatus is such that the first sensor and the second sensor are in communication with the receiver.

Optionally, the apparatus is such that the first sensor and the second sensor are oppositely disposed from each other at the vertically oriented top and bottom ends the boiler tank.

Optionally, the apparatus is such that it additionally comprises a display and a transmitter, the transmitter in communication with the processor, and for transmitting the length of time of available water usage at the predetermined temperature.

Optionally, the apparatus is such that the predetermined temperature is between approximately 370 to approximately 40°.

Optionally, the apparatus is such that the boiler tank includes a non-stratified boiler tank.

Optionally, the apparatus is such that the boiler tank includes a stratified boiler tank.

Optionally, the apparatus is such that the water usage includes a shower.

Embodiments of the disclosed subject matter are directed to a computer usable non-transitory storage medium having a computer program embodied thereon for causing a suitably programmed system to determine a time length for water usage at a predetermined temperature, by performing the following steps when such program is executed by the system. The steps comprise: measuring at least one temperature of a boiler tank; and, based on the at least the measured temperature, a volume of the boiler, and, a flow rate of liquid from the boiler tank, determining a length of time available for water usage at the predetermined temperature.

Optionally, the computer usable non-transitory storage medium is such that the predetermined temperature is between approximately 370 to approximately 40°.

Optionally, the computer usable non-transitory storage medium is such that the measuring the at least one temperature includes measuring the at least one temperature (T_{BOT}), either at, or proximate to, a bottom of the boiler tank.

Optionally, the computer usable non-transitory storage medium is such that the measuring the at least one temperature incudes measuring a second temperature (T_{TOP}), either at or proximate to a top of the boiler tank.

Optionally, the computer usable non-transitory storage medium is such that the measuring the bottom of the boiler tank and the top of the boiler tank are at oppositely disposed vertically oriented ends of the boiler tank.

Optionally, the computer usable non-transitory storage medium is such that the boiler tank includes a non-stratified boiler tank.

Optionally, the computer usable non-transitory storage medium is such that the boiler tank includes a stratified boiler tank.

Optionally, the computer usable non-transitory storage medium is such that the water usage includes a shower.

The implementation of the method and/or system of embodiments of the disclosure can involve performing or completing selected tasks manually, automatically, or a combination thereof. Moreover, according to actual instrumentation and equipment of embodiments of the method and/or system of the disclosure, several selected tasks could be implemented by hardware, by software or by firmware or by a combination thereof using an operating system or a cloud-based platform (such as those provided by Amazon Web Services™ or Microsoft® Azure™).

For example, hardware for performing selected tasks according to embodiments of the disclosure could be implemented as a chip or a circuit. As software, selected tasks according to embodiments of the disclosure could be implemented as a plurality of software instructions being executed by a computer using any suitable operating system. In an exemplary embodiment of the disclosure, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present disclosure. The non-transitory computer readable (storage) medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes, and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes, and is not intended to limit any of such computer-implemented methods disclosed herein.

The flowcharts and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

The above-described processes including portions thereof can be performed by software, hardware and combinations thereof. These processes and portions thereof can be performed by computers, computer-type devices, workstations, cloud-based platforms, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques. Descriptions of embodiments of the disclosure in the present application are provided by way of example and are not intended to limit the scope of the disclosure. The described embodiments comprise different features, not all of which are required in all embodiments of the disclosure. Some embodiments utilize only some of the features or possible combinations of the features. Variations of embodiments of the disclosure that are described, and embodiments of the disclosure comprising different combinations of features noted in the described embodiments, will occur to persons of the art. The scope of the disclosure is limited only by the claims.

1. A method for determining a time length for water usage at a predetermined temperature, comprising:
in a boiler tank for holding water, the boiler tank including an oppositely disposed top portion and a bottom portion, measuring, by a first sensor at the bottom portion of the boiler tank, a first temperature (T_{BOT}) for the water therein, and, measuring, by a second sensor at the top portion of the boiler tank, a second temperature (T_{TOP}) for the water therein; and,
based on the at least the measured temperatures, a volume of the boiler tank, and, a flow rate of water at a point of use, determining a length of time available for water usage at the point of use at the predetermined temperature.

2. The method of claim 1, wherein the predetermined temperature is between approximately 370 to approximately 40°.

3. The method of claim 1, wherein the measuring the temperature at the bottom portion of the boiler tank and the top portion of the boiler tank is at oppositely disposed vertically oriented ends of the boiler tank.

4. The method of claim 1, wherein the boiler tank includes a non-stratified boiler tank.

5. The method of claim 1, wherein the boiler tank includes a stratified boiler tank.

6. The method of claim 1, wherein the point of use includes a shower.

7. The method of claim 1, wherein the determining a length of time available for water usage at the predetermined temperature (T_{AV}) is determined by the equation:
T_{AV}=(T_{VB}·K₁)−K₂,
where, K₁ is a constant of 45.009, K2 is a constant of 1170.1, and T_{VB} is a virtual bottom temperature, expressed by the equation:
T_{VB}=(ΔT·K_{BV})+T_{BOT},
where, ΔT is a temperature difference determined in accordance with the equation:
ΔT=T_{TOP}−T_{BOT},
where, T_{TOP} is the measured temperature from either at or proximate to a top of the boiler tank, and T_{BOT} is the measured temperature from either at or proximate to the bottom of the boiler tank, and K_{BV} is a constant based on the volume of the boiler tank of 0.3.

8. An apparatus for determining a time length for water usage at a predetermined temperature, comprising:
a receiver for receiving 1) at least one first water temperature (T_{BOT}) from a first sensor in communication with a bottom portion of a boiler tank, and 2) at least one second water temperature (T_{TOP}) from a second sensor in communication with a top portion of the boiler tank;
a non-transitory storage medium for storing the received at least one first water temperature and the at least one second water temperature; and
a computerized processor in communication with the receiver and the non-transitory storage medium, the processor programmed to: determine a length of time available for water usage at a point of use at the predetermined temperature, based on the at least the received at least one first temperature and the at least one second temperature, a volume of the boiler, and, a flow rate of water at the point of use.

9. The apparatus of claim 8, wherein the at least one first sensor is at or proximate to the bottom portion of the boiler tank, and, the at least one second sensor is at or proximate to the top portion of the boiler tank.

10. The apparatus of claim 8, wherein the first sensor and the second sensor are in communication with the receiver.

11. The apparatus of claim 8, wherein the first sensor and the second sensor are oppositely disposed from each other at the vertically oriented top and bottom ends the boiler tank.

12. The apparatus of claim 8, additionally comprising a display and a transmitter, the transmitter in communication with the processor, and for transmitting the length of time of available water usage at the predetermined temperature.

13. The apparatus of claim 8, wherein the predetermined temperature is between approximately 370 to approximately 40°.

14. The apparatus of claim 8, wherein the boiler tank includes a non-stratified boiler tank.

15. The apparatus of claim 8, wherein the boiler tank includes a stratified boiler tank.

16. The apparatus of claim 8, wherein the point of use includes a shower.

17. The apparatus of claim 8, wherein the processor is programmed to determine the length of time available for water usage at the predetermined temperature (T_{AV}) by applying the equation:
T_{AV}=(T_{VB}·K₁)−K₂,
where, K₁ is a constant of 45.009, K2 is a constant of 1170.1, and T_{VB} is a virtual bottom temperature, expressed by the equation:
T_{VB}=(ΔT·K_{BV})+T_{BOT},
where, ΔT is a temperature difference determined in accordance with the equation:
ΔT=T_{TOP}−T_{BOT},
where, T_{TOP} is the measured temperature from either at or proximate to a top of the boiler tank, and T_{BOT} is the measured temperature from either at or proximate to the bottom of the boiler tank, and K_{BV} is a constant based on the volume of the boiler tank of 0.3.

18. A computer usable non-transitory storage medium having a computer program embodied thereon for causing a suitably programmed system to determine a time length for water usage at a predetermined temperature, by performing the following steps when such program is executed by the system, the steps comprising:
in a boiler tank for holding water, the boiler tank including an oppositely disposed top portion and a bottom portion, measuring by a first sensor at the bottom portion of the boiler tank, a first temperature (T_{BOT}) for the water therein, and, measuring, by a second sensor at the top portion of the boiler tank a second temperature (T_{TOP}) for the water therein; and,
based on the at least the measured temperatures, a volume of the boiler, and, a flow rate of water at a point of use, determining a length of time available for water usage at the point of use at the predetermined temperature.

19. The computer usable non-transitory storage medium of claim 18, wherein the predetermined temperature is between approximately 370 to approximately 40°.

20. The computer usable non-transitory storage medium of claim 18, wherein the measuring the bottom of the boiler tank and the top of the boiler tank are at oppositely disposed vertically oriented ends of the boiler tank.

21. The computer usable non-transitory storage medium of claim 18, wherein the boiler tank includes a non-stratified boiler tank.

22. The computer usable non-transitory storage medium of claim 18, wherein the boiler tank includes a stratified boiler tank.

23. The computer usable non-transitory storage medium of claim 18, wherein the point of use includes a shower.

24. The computer usable non-transitory storage medium of claim 18, wherein the determining a length of time available for water usage at the predetermined temperature (T_{AV}) is determined by the equation:
T_{AV}=(T_{VB}·K₁)−K₂,
where, K₁ is a constant of 45.009, K2 is a constant of 1170.1, and T_{VB} is a virtual bottom temperature, expressed by the equation:
T_{VB}=(ΔT·K_{BV})+T_{BOT},
where, ΔT is a temperature difference determined in accordance with the equation:
ΔT=T_{TOP}−T_{BOT},
where, T_{TOP} is the measured temperature from either at or proximate to a top of the boiler tank, and T_{BOT} is the measured temperature from either at or proximate to the bottom of the boiler tank, and K_{BV} is a constant based on the volume of the boiler tank of 0.3.

25. The method of claim 1, wherein the boiler tank is oriented one of vertically or horizontally.
